(19) United States
(12) Patent Application Publication
(10) Pub. No.: US 2013/0065114 A1
(43) Pub. Date: Mar. 14, 2013

(54) POLYMER ELECTROLYTE, MANUFACTURING METHOD FOR POLYMER ELECTROLYTE, IMIDE MONOMER, AND BATTERY

(71) Applicants: Akihiro Shinohara, Aichi-gun (JP); Naoki Hasegawa, Aichi-gun (JP); Masaya Kawasumi, Anjyo-shi (JP); Masayoshi Takami, Hamamatsu-shi (JP); Toshihiko Yoshida, Fujimi-shi (JP)

(72) Inventors: Akihiro Shinohara, Aichi-gun (JP); Naoki Hasegawa, Aichi-gun (JP); Masaya Kawasumi, Anjyo-shi (JP); Masayoshi Takami, Hamamatsu-shi (JP); Toshihiko Yoshida, Fujimi-shi (JP)

(73) Assignee: TOYOTA JIDOSHA KABUSHIKI KAISHA, Toyota-shi, Aichi-ken (JP)

(21) Appl. No.: 13/699,222

(22) PCT Filed: May 19, 2011
(86) PCT No.: PCT/IB11/01080

§ 371 Date: Nov. 20, 2012

(30) Foreign Application Priority Data
May 20, 2010 (JP) 2010-116677

(51) Int. Cl. H01M 10/0564

(52) U.S. Cl. 429/200

(57) ABSTRACT

A polymer electrolyte includes a fluorine-containing structure having an alicyclic 1,3-disulfonimide in a principal chain or side chain of the polymer. A battery includes the polymer electrolyte. An imide monomer is able to introduce a fluorine-containing structure having an alicyclic 1,3-disulfonimide into a principal chain or side chain of a polymer through a polymerization reaction or a combination of a polymerization reaction and a fluorination reaction. A manufacturing method for a polymer electrolyte includes a polymerization step of polymerizing a raw material that includes one or two or more types of imide monomers that are able to introduce a fluorine-containing structure having an alicyclic 1,3-disulfonimide into a principal chain or side chain of a polymer through a polymerization reaction or a combination of a polymerization reaction and a fluorination reaction.

### BACKGROUND OF THE INVENTION

1. Field of the Invention

The invention relates to a polymer electrolyte, a manufacturing method for the polymer electrolyte, an imide monomer and a battery. More particularly, the invention relates to a polymer electrolyte that has a high softening temperature, a high oxygen permeability and a high proton conductivity, a manufacturing method for the polymer electrolyte, an imide monomer that may be used as a raw material of such a polymer electrolyte, and a battery, such as a fuel cell, a secondary battery and a solar battery, that uses such a polymer electrolyte.

2. Description of Related Art

A polymer electrolyte fuel cell includes a membrane electrode assembly (MEA) as a base unit. The MEA is formed so that electrodes are combined to both surfaces of a solid polymer electrolyte membrane. In addition, in the polymer electrolyte fuel cell, each electrode generally has a double layer structure formed of a diffusion layer and a catalyst layer. The diffusion layer supplies reaction gas and electrons to the catalyst layer. Carbon paper, carbon cloth, or the like, is used as the diffusion layer. In addition, the catalyst layer is a reaction field of electrode reaction. The catalyst layer is generally formed of a complex of carbon that supports an electrode catalyst, such as platinum, and a solid polymer electrolyte (catalyst layer ionomer).

A high oxidation resistant fluorocarbon-based electrolyte (for example, Nafion (trademark, produced by DuPont), Aciplex (trademark, produced by Asahi Kasei Corporation), Flemion (trademark, produced by Asahi Glass Co., Ltd.), or the like) is generally used for the electrolyte membrane or catalyst layer ionomer that constitutes such an MEA. In addition, the fluorocarbon-based electrolyte has a high oxidation resistance; however, it is generally considerably expensive. Therefore, in order to reduce the cost of a polymer electrolyte fuel cell, usage of a hydrocarbon-based electrolyte has also been studied.

However, in order to use a polymer electrolyte fuel cell as an in-vehicle power source, or the like, there are some problems to be solved. For example, in order to obtain high performance in a polymer electrolyte fuel cell, the higher operating temperature of the fuel cell is desirable. For this reason, the electrolyte membrane desirably has a high heat resistance. However, there is a problem that an existing fluorine-based electrolyte membrane is low in mechanical strength at high temperatures. In addition, in order to spread the use of a fuel cell vehicle, cost reduction of a fuel cell is a challenge. For this reason, the amount of platinum used for the catalyst needs to be reduced. In order to reduce the amount of platinum, development of a catalyst layer ionomer having a high proton conductivity and a high oxygen permeability is required.

Then, in order to solve the above problems, various suggestions have been offered. For example, International Application Publication No. WO2005/096422 describes a synthesis method for monomers having an alicyclic structure and a synthesis method for a copolymer using these monomers. WO2005/096422 describes that a copolymer that has a high softening temperature and that allows high temperature operation is obtainable by introducing an acid radical into an alicyclic monomer. In addition, Japanese Patent Application Publication No. 2007-204599 (JP-A-2007-204599) describes a manufacturing method for a five-membered ring structure or a six-membered ring structure that is obtainable by subjecting diallylamine to radical polymerization.

In addition, various suggestions have also been offered for not electrolytes but chemical compounds having a ring structure, chemical compounds used to form a ring structure and manufacturing methods for the compounds. For example, Research Report of Asahi Glass Co., Ltd., 2005, vol. 55, p 47-51, (Transparent Fluororesin “Cytop”—Research for Basic Properties and Polymerization Rate of Perfluorodiene) describes a synthesis of Cytop through a cyclization reaction of BVE and its applications. In addition, Japanese Patent Application Publication No. 2008-230990 (JP-A-2008-230990) describes a synthesis method for a cyclic sulfonimide that is obtainable by reacting a chemical compound having an SO₂F group at both terminals with ammonium carbonate. In addition, International Application Publication No. WO2006/106960 describes a synthesis method for FO₂SCFClCFClSO₂F and a synthesis method for a cyclic disulfonimide using FO₂SCFClCFClSO₂F. In addition, Canadian Journal of Chemistry, 2004, 82, 1186-1191 describes a method of obtaining a fluorine-containing vinylidene group (>C═CF₂) by reacting PPh₃ and CFBr₂ with a ketone group (>C═O). In addition, Japanese Patent Application Publication No. 2004-18429 (JP-A-2004-18429) describes a method in which CFCl═CFCl is added to a —OF group and is then reduced. Furthermore, Zhurnal Organicheskoi Khimii, 1983, 19, 1343-1344 describes a synthesis method for a chemical compound having a ketone group and two SO₂F groups.

In order to improve the efficiency of a fuel cell, a higher operating temperature is desirable. For this reason, an electrolyte membrane and a catalyst layer ionomer need to have a high softening temperature. In addition, in order to facilitate a cathode-side electrode reaction, oxygen and protons need to be efficiently supplied to a catalyst covered with the catalyst layer ionomer. For this reason, a cathode-side catalyst layer ionomer needs to have a high oxygen permeability and a high proton conductivity. However, there is no example that suggests a polymer electrolyte having a high softening temperature, a high oxygen permeability and a high proton conductivity. In addition, there is no example that suggests a monomer suitable for manufacturing such a polymer electrolyte.

### SUMMARY OF THE INVENTION

The invention provides a polymer electrolyte that has a high softening temperature, a high oxygen permeability and a high proton conductivity and a manufacturing method for the polymer electrolyte. In addition, the invention provides an imide monomer that may be used as the raw material of such a polymer electrolyte. Furthermore, the invention provides a battery, such as a fuel cell, a secondary battery and a solar battery, that uses such a polymer electrolyte.

A first aspect of the invention relates to a polymer electrolyte. The polymer electrolyte includes a fluorine-containing structure having an alicyclic 1,3-disulfonimide in its principal chain or side chain. The polymer electrolyte according to the first aspect of the invention may have a structure expressed by any one of the following structural formulas (1.1) to (1.4).

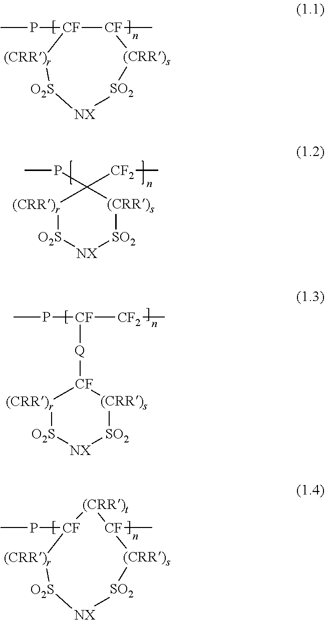

where r, s and t each are an integer larger than or equal to 0; n is an integer larger than or equal to 1; P is a direct bond, a first perfluorocarbon or a hydrocarbon, and the first perfluorocarbon or the hydrocarbon each may include an ether bond and/or a sulfonyl bond; R and R′ each are fluorine or a second perfluorocarbon having a carbon number of 1 to 10, the second perfluorocarbon may include an ether bond and/or a sulfonyl bond, and R and R′ may be the same or may be different from each other in a ring structure; X is hydrogen, an alkali metal or a cation that forms a salt with 1,3-disulfonimide; and Q is a direct bond, oxygen or a third perfluorocarbon having a carbon number of 1 to 10, and the third perfluorocarbon may include an ether bond and/or a sulfonyl bond.

A second aspect of the invention relates to an imide monomer. The imide monomer is able to introduce a fluorine-containing structure having an alicyclic 1,3-disulfonimide into a principal chain or side chain of a polymer through a polymerization reaction or a combination of a polymerization reaction and a fluorination reaction. The imide monomer according to the second aspect may have a structure expressed by any one of the following structural formulas (3.1) to (3.5).

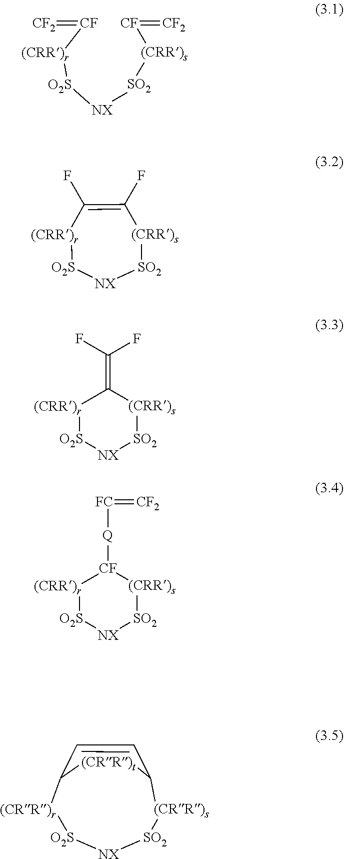

where r, s and t each are an integer larger than or equal to 0; R and R′ each are fluorine or a second perfluorocarbon having a carbon number of 1 to 10, the second perfluorocarbon may include an ether bond and/or a sulfonyl bond, and R and R′ may be the same or may be different from each other in a molecule; X is hydrogen, an alkali metal or a cation that forms a salt with 1,3-disulfonimide; Q is a direct bond, oxygen or a third perfluorocarbon having a carbon number of 1 to 10, and the third perfluorocarbon may include an ether bond and/or a sulfonyl bond; and R″ is hydrogen or a hydrocarbon having a carbon number of 1 to 10, and R″ may be the same or may be different from each other in the molecule.

A third aspect of the invention relates to a manufacturing method for a polymer electrolyte. The manufacturing method includes a polymerization step of polymerizing a raw material that includes one or two or more types of imide monomers that are able to introduce a fluorine-containing structure having an alicyclic 1,3-disulfonimide into a principal chain or side chain of a polymer through a polymerization reaction or a combination of a polymerization reaction and a fluorination reaction. The one or two or more types of imide monomers each may have a structure expressed by any one of the above described structural formulas (3.1) to (3.5). Furthermore, a fourth aspect of the invention relates to a battery. The battery includes the polymer electrolyte according to the first aspect of the invention.

The polymer electrolyte according to the aspects of the invention has an alicyclic structure in its molecule, so the polymer electrolyte has a high softening temperature. Therefore, when the polymer electrolyte is used for a fuel cell, the fuel cell may be operated at high temperatures. In addition, the oxygen permeability of the polymer electrolyte improves by introducing an alicyclic structure into the molecule. Furthermore, a sulfonimide group (—SO₂NHSO₂—) included in a fluorine-containing structure having an alicyclic 1,3-disulfonimide functions as a strong acid group. Therefore, when the fluorine-containing structure is introduced into a principal chain or side chain of a polymer, the proton conductivity of a polymer electrolyte may be enhanced while high oxygen permeability is maintained.

### DETAILED DESCRIPTION OF EMBODIMENTS

### 1. Polymer Electrolyte

### 1.1. Composition

A polymer electrolyte according to a first embodiment of the invention includes a fluorine-containing structure having an alicyclic 1,3-disulfonimide in its principal chain or side chain. Here, the “fluorine-containing structure having an alicyclic 1,3-disulfonimide” has a ring structure of which both terminals of a disulfonimide (—SO₂NHSO₂—) are linked via at least one carbon atom and which is linked with a chain perfluorocarbon. The ring structure may be formed so that part of the ring constitutes part of the chain perfluorocarbon. Alternatively, the ring structure may be bonded with the chain perfluorocarbon via another structure (for example, structure Q described later). The structure of the chain perfluorocarbon is not specifically limited; it may be any one of a linear structure and a branched structure.

The fluorine-containing structure having an alicyclic 1,3-disulfonimide (hereinafter, also simply referred to as “alicyclic imide structure”) may be bonded with any one of a principal chain or side chain of the polymer. In addition, the polymer electrolyte may include only one type of alicyclic imide structure or may include two or more types of alicyclic structures in its principal chain or side chain. Furthermore, the polymer electrolyte may be formed of only a repetition of only an alicyclic imide structure. Alternatively, the polymer electrolyte may be formed so that an alicyclic imide structure and another structure (structure P described later) are alternately or randomly bonded with each other.

### 1.2. Specific Example

The polymer electrolyte according to a specific example of the invention just needs to include at least one alicyclic imide structure in its principal chain or side chain, and the structure of the other portions is not specifically limited. Examples of the polymer electrolyte are expressed by the following structural formulas (1.1) to (1.4). Note that, in the structural formulas (1.1) to (1.4), the “alicyclic imide structure” means a portion, other than the structure P, in each of the structural formulas (1.1) to (1.4).

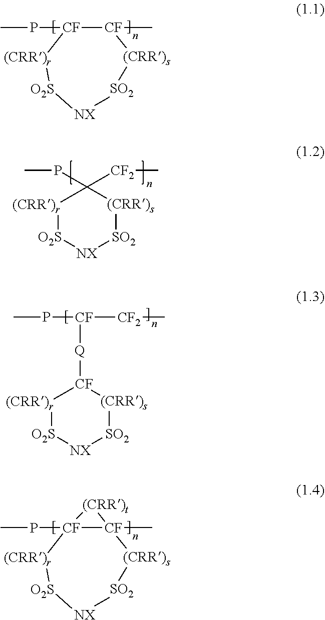

where r, s and t each are an integer larger than or equal to 0; n is an integer larger than or equal to 1; P is a direct bond, a first perfluorocarbon or a hydrocarbon, and the first perfluorocarbon or the hydrocarbon each may include an ether bond and/or a sulfonyl bond; R and R′ each are fluorine or a second perfluorocarbon having a carbon number of 1 to 10, the second perfluorocarbon may include an ether bond and/or a sulfonyl bond, and R and R′ may be the same or may be different from each other in a ring structure; X is hydrogen, an alkali metal or a cation that forms a salt with 1,3-disulfonimide; and Q is a direct bond, oxygen or a third perfluorocarbon having a carbon number of 1 to 10, and the third perfluorocarbon may include an ether bond and/or a sulfonyl bond.
1.2.1. Regarding “r, s and t”

In the structural formulas (1.1) to (1.4), r, s and t each are an integer larger than or equal to 0. r, s and t are associated with a carbon number incorporated in a ring structure. Generally, as at least any one of r, s and t increases, the diameter of the ring structure increases, so the oxygen permeability improves. On the other hand, as at least any one of r, s and t excessively increases, the number of sulfonimide groups per unit weight reduces, so the proton conductivity decreases. In the polymer electrolyte having the structure expressed by the structural formula (1.1), in order to achieve both high oxygen permeability and high proton conductivity, the sum of r and s is desirably larger than or equal to 0 and smaller than or equal to 5, and is more desirably larger than or equal to 0 and smaller than or equal to 2. In the polymer electrolyte having the structure expressed by the structural formula (1.2), in order to achieve both high oxygen permeability and high proton conductivity, the sum of r and s is larger than or equal to 0 and smaller than or equal to 6, and is more desirably larger than or equal to 0 and smaller than or equal to 3. In the polymer electrolyte having the structure expressed by the structural formula (1.3), in order to achieve both high oxygen permeability and high proton conductivity, the sum of r and s is larger than or equal to 0 and smaller than or equal to 6, and is more desirably larger than or equal to 0 and smaller than or equal to 3. Furthermore, in the polymer electrolyte having the structure expressed by the structural formula (1.4), in order to achieve both high oxygen permeability and high proton conductivity, the sum of r and s is larger than or equal to 0 and smaller than or equal to 5, and is more desirably larger than or equal to 0 and smaller than or equal to 2.

1.2.2. Regarding “n”

In the structural formulas (1.1) to (1.4), n is an integer larger than or equal to 1. n indicates the number of repetitions of the alicyclic imide structure. n is not specifically limited, and it may be arbitrarily selected depending on a purpose. When the polymer electrolyte includes both an alicyclic imide structure and a structure P other than a direct bond, the polymer electrolyte is a so-called copolymer. In addition, when the polymer electrolyte includes an alicyclic imide structure and a structure P other than a direct bond and both the molecular weight of the alicyclic imide structure and the molecular weight of P are relatively large, the polymer electrolyte is a so-called block copolymer. In the specific example of the invention, the “block copolymer” is a polymer that is formed of a segment A formed of an alicyclic 1,3-disulfonimide portion and a segment B formed of P and each of the molecular weight of the segment A and the molecular weight of the segment B is larger than or equal to 1×10³. Each of the molecular weight of the segment A and the molecular weight of the segment B is more desirably larger than or equal to 2×10³.

### 1.2.3. Regarding “P”

In the structural formulas (1.1) to (1.4), P denotes a direct bond, a first perfluorocarbon or a hydrocarbon. The first perfluorocarbon or the hydrocarbon each may include an ether bond and/or a sulfonyl bond. When P is a first perfluorocarbon or a hydrocarbon, the structure and molecular weight of P are not specifically limited, and may be arbitrarily selected depending on a purpose. For example, when P is a first perfluorocarbon, the structure of P may be any one of a linear structure and a branched structure. Similarly, when P is a hydrocarbon, the structure of P may be any one of a linear structure and a branched structure.

When the polymer electrolyte is a copolymer, P is desirably a first perfluorocarbon in order to improve the radical resistance of the polymer electrolyte. In this case, the molecular weight of P is not specifically limited, and it may be arbitrarily selected depending on a purpose. On the other hand, when the polymer electrolyte is a block copolymer, the alicyclic imide structures tend to be associated with one another to form a large cluster. A radical is mainly present in a cluster of the alicyclic imide structures, so the structure P does not need to be a first perfluorocarbon in order to improve the radical resistance of the polymer electrolyte. In the case where the polymer electrolyte is a block copolymer, when a hydrocarbon is used as the structure P, the cost of the polymer electrolyte may be reduced without decreasing the radical resistance of the polymer electrolyte.

When P is a first perfluorocarbon, specifically, P is desirably any one of the structures expressed by the following structural formulas (2.1) to (2.6). In this case, the polymer electrolyte may include any one of the structural formulas (2.1) to (2.6) or may include any two or more of the structural formulas (2.1) to (2.6).

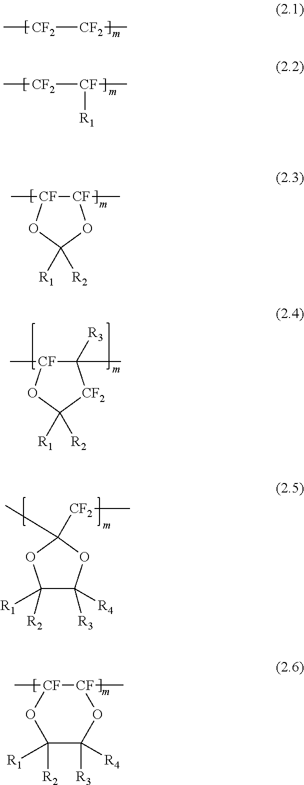

where m is an integer larger than or equal to 1; R₁ to R₄ each are fluorine or a fourth perfluorocarbon having a carbon number of 1 to 10, and the fourth perfluorocarbon may include an ether bond and/or a sulfonyl bond.

m indicates the number of repetitions of the first perfluorocarbon. m is not specifically limited, and it may be arbitrarily selected depending on a purpose. When the polymer electrolyte includes an alicyclic imide structure and a structure P other than a direct bond, the polymer electrolyte is a so-called copolymer. In addition, when the polymer electrolyte includes an alicyclic imide structure and a structure P other than a direct bond and both the molecular weight of the alicyclic imide structure and the molecular weight of P are relatively large, the polymer electrolyte is a so-called block copolymer.

As the carbon number of the fourth perfluorocarbon increases, the oxygen permeability increases. On the other hand, as the carbon number of the fourth perfluorocarbon excessively increases, the proton conductivity decreases. Thus, the carbon number of the fourth perfluorocarbon is desirably larger than or equal to 1 and smaller than or equal to 10. The structure of the fourth perfluorocarbon is not specifically limited, and may be any one of a linear structure and a branched structure.

When P is a hydrocarbon, specifically, the hydrocarbon is desirably (1) polyethylene (—(CH₂)ₙ—), (2) polycyclohexane (—(C₆H₈)ₙ—), (3) polystyrene (—[CH(C₆H₅)—CH]ₙ—), (4) polyparaphenylene, polyetheretherketone, or the like. In this case, P may be any one of the above described hydrocarbons or may be a combination of any two or more of the above described hydrocarbons. Furthermore, P may be a combination of one or two or more of first perfluorocarbons and one or two or more of hydrocarbons.

### 1.2.4. Regarding “R and R”

In the structural formulas (1.1) to (1.4), R and R′ each are fluorine or a second perfluorocarbon having a carbon number of 1 to 10. The second perfluorocarbon may include an ether bond and/or a sulfonyl bond. R and R′ may be the same or may be different from each other in the ring structure.

As the carbon number of the second perfluorocarbon increases, the oxygen permeability increases. On the other hand, as the carbon number of the second perfluorocarbon excessively increases, the proton conductivity decreases. Thus, the carbon number of the second perfluorocarbon is desirably larger than or equal to 1 and smaller than or equal to 10. The structure of the second perfluorocarbon is not specifically limited, and may be any one of a linear structure and a branched structure.

### 1.2.5. Regarding “X”

In the structural formulas (1.1) to (1.4), X is hydrogen, an alkali metal or a cation that forms a salt with 1,3-disulfonimide. The alkali metal is desirably Li, Na or K. In addition, the cation is desirably NH₄⁺, NHEt₃⁺, NH(i-Pr)₂Et⁺, or the like.

### 1.2.5. Regarding “Q”

In the structural formula (1.3), Q is a direct bond, oxygen or a third perfluorocarbon having a carbon number of 1 to 10. The third perfluorocarbon may include an ether bond and/or a sulfonyl bond. As the carbon number of the third perfluorocarbon increases, the oxygen permeability increases. On the other hand, as the carbon number of the third perfluorocarbon excessively increases, the proton conductivity decreases. Thus, the carbon number of the third perfluorocarbon is desirably larger than or equal to 1 and smaller than or equal to 10. The structure of the third perfluorocarbon is not specifically limited, and may be any one of a linear structure and a branched structure. Particularly, Q is desirably oxygen. This is because steric hindrance is eliminated to make it possible to enhance the degree of polymerization.

### 2. Imide Monomer

### 2.1. Composition

An imide monomer according to a second embodiment of the invention is able to introduce a fluorine-containing structure having an alicyclic 1,3-disulfonimide into a principal chain or side chain of a polymer through a polymerization reaction or a combination of a polymerization reaction and a fluorination reaction. The imide monomer has a polymerizable functional group. The polymerizable functional group is, for example, a carbon-carbon double bond, a carbon-carbon triple bond, an amide, a sulfonyl halide, an alcohol, a lactone, a lactam, iodine, or the like. The imide monomer just needs to be able to introduce an alicyclic imide structure into a principal chain or side chain of a polymer at the time when a polymerization reaction ends or at the time when a combination of a polymerization reaction and a fluorination reaction ends. Thus, the molecule of the imide monomer may include in advance an alicyclic imide structure or a ring structure (precursor) that becomes an alicyclic imide structure through a fluorination reaction. Alternatively, the imide monomer may be the one such that the polymerizable functional group is cleaved to form an alicyclic imide structure or a precursor of the alicyclic imide structure.

### 2.2. Specific Example

An imide monomer according to a specific example of the invention just needs to be able to introduce at least one type of alicyclic imide structure into a principal chain or side chain of a polymer, and the structure of the other portions is not specifically limited. Examples of the imide monomer according to the second embodiment of the invention are expressed by the following structural formulas (3.1) to (3.5). The imide monomers expressed by the structural formulas (3.1) to (3.4) introduce an alicyclic imide structure into a principal chain or side chain of a polymer at the time when a polymerization reaction ends. Note that the details of r, s, R, R′, X and Q are as described above, so the description thereof is omitted. The imide monomer expressed by the structural formula (3.5) is subjected to a polymerization reaction and then further subjected to a fluorination reaction to thereby introduce an alicyclic imide structure into a principal chain or side chain of a polymer. In the structural formula (3.5), R″ denotes hydrogen or a hydrocarbon. In the case where R″ is a hydrocarbon, when it is subjected to fluorination, as the carbon number of the fluorinated perfluorocarbon (R, R′) increases, the oxygen permeability increases. On the other hand, as the carbon number of R″ excessively increases, the proton conductivity of the fluorinated perfluorocarbon (R, R′) decreases. Thus, in the case where R″ is a hydrocarbon, the carbon number is desirably 1 to 10.

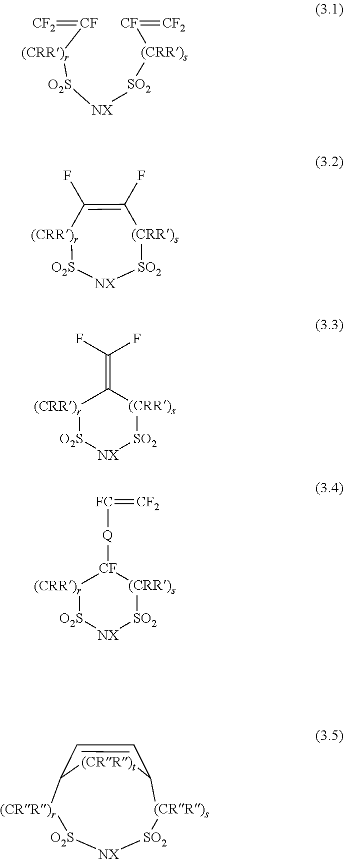

where r, s and t each are an integer larger than or equal to 0; R and R′ each are fluorine or a second perfluorocarbon having a carbon number of 1 to 10, the second perfluorocarbon may include an ether bond and/or a sulfonyl bond, and R and R′ may be the same or may be different from each other in a molecule; X is hydrogen, an alkali metal or a cation that forms a salt with 1,3-disulfonimide; Q is a direct bond, oxygen or a third perfluorocarbon having a carbon number of 1 to 10, and the third perfluorocarbon may include an ether bond and/or a sulfonyl bond; and R″ is hydrogen or a hydrocarbon having a carbon number of 1 to 10, and R″ may be the same or may be different from each other in the molecule.

### 3. Manufacturing Method for Polymer Electrolyte

### 3.1. Polymerization Step

A manufacturing method for a polymer electrolyte according to a third embodiment of the invention includes a polymerization step of polymerizing a raw material that includes one or two or more types of imide monomers that are able to introduce a fluorine-containing structure having an alicyclic 1,3-disulfonimide into a principal chain or side chain of a polymer through a polymerization reaction or a combination of a polymerization reaction and a fluorination reaction.

### 3.1.1. Raw Material

The raw material just needs to include at least one type of imide monomer. The details of the imide monomer are as described above, so the description thereof is omitted. The raw material is specifically (1) a raw material that includes one or two or more types of imide monomers only, (2) a raw material that includes one or two or more types of imide monomers and one or two or more types of second monomers having a polymerizable functional group (hydrocarbon-based monomers or fluorocarbon-based monomers), (3) a raw material that includes one or two or more types of imide monomers and one or two or more types of second polymers having a polymerizable functional group (hydrocarbon-based polymers or fluorocarbon-based polymers), (4) a raw material that includes one or two or more types of imide monomers, one or two or more types of second monomers having a polymerizable functional group and one or two or more types of second polymers having a polymerizable functional group, or the like.

When a copolymer of which P is a first perfluorocarbon is synthesized, a fluorocarbon-based monomer is used as a second monomer. In addition, when a block copolymer of which P is a first perfluorocarbon is synthesized, a fluorocarbon-based monomer is used as a second monomer or a fluorocarbon-based polymer is used as a second polymer. The fluorocarbon-based monomer is specifically, for example, any one of the monomers expressed by the following structural formulas (4.1) to (4.6). The second monomers expressed by the structural formulas (4.1) to (4.6) are commercially available or may be manufactured using commercially available chemical compounds through a known method. The fluorocarbon-based polymer is specifically, for example, a polymer obtained by polymerizing any one of the monomers expressed by the structural formulas (4.1) to (4.6) or a block polymer obtained through iodine migration polymerization (for example, see Japanese Patent Publication No. 58-4728).

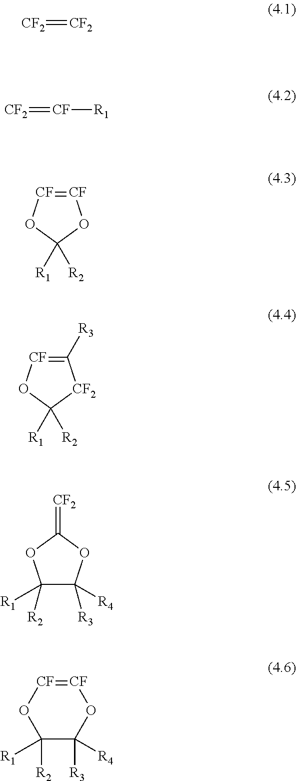

where R₁ to R₄ each are fluorine or a fourth perfluorocarbon having a carbon number of 1 to 10, and the fourth perfluorocarbon may include an ether bond and/or a sulfonyl bond. The details of R₁ to R₄ are as described above, so the description thereof is omitted.

When a copolymer of which P is a hydrocarbon is synthesized, a hydrocarbon-based monomer is used as a second monomer. In addition, when a block copolymer of which P is a hydrocarbon is synthesized, a hydrocarbon-based monomer is used as a second monomer or a hydrocarbon-based polymer is used as a second polymer. The hydrocarbon-based monomer is specifically, for example, ethylene (CH₂═CH₂), styrene (CH(C₆H₅)═CH₂) or cyclohexene (CH(C₆H₁₁)═CH₂). The hydrocarbon-based polymer is specifically, for example, polyparaphenylene, polyetheretherketone or polystyrene. These hydrocarbon-based monomers and hydrocarbon-based polymers are commercially available or may be manufactured using commercially available chemical compounds through a known method.

### 3.1.2. Polymerization Method

A polymerization method for an imide monomer and a second monomer or second polymer that is added where necessary is not specifically limited, and a known method may be used. The polymerization method is, specifically, for example, radical polymerization, plasma polymerization, bulk polymerization, solution polymerization, suspension polymerization, emulsion polymerization, miniemulsion polymerization or microemulsion polymerization. For example, when a raw material that includes one or two or more types of imide monomers only is polymerized, a polymer electrolyte in which the same or different alicyclic imide structures are bonded with each other is obtained. In addition, for example, when one or two or more types of imide monomers and one or two or more types of second monomers having a polymerizable functional group are copolymerized, a copolymer in which alicyclic imide structures are bonded via a perfluorocarbon or a hydrocarbon is obtained. In addition, for example, when one or two or more types of imide monomers and one or two or more types of fluorocarbon-based polymers or hydrocarbon-based polymers having a polymerizable functional group are block copolymerized, a block copolymer in which an alicyclic imide structure having a large molecular weight and a fluorocarbon-based polymer or hydrocarbon-based polymer having a large molecular weight are bonded with each other is obtained.

### 3.2. Fluorination Step

As in the case of the imide monomer expressed by the structural formula (3.5), depending on the type of imide monomer, a precursor of an alicyclic imide structure may be introduced into a polymer chain at the time when a polymerization reaction ends. In such a case, a fluorination reaction needs to be performed after a polymerization reaction ends. A method for a fluorination reaction is not specifically limited, and a known method may be used. An example of the reaction formula in which the imide monomer expressed by the structural formula (3.5) is subjected to ring-opening metathesis polymerization (ROMP) and then subjected to a fluorination reaction is expressed by the following formula (a).

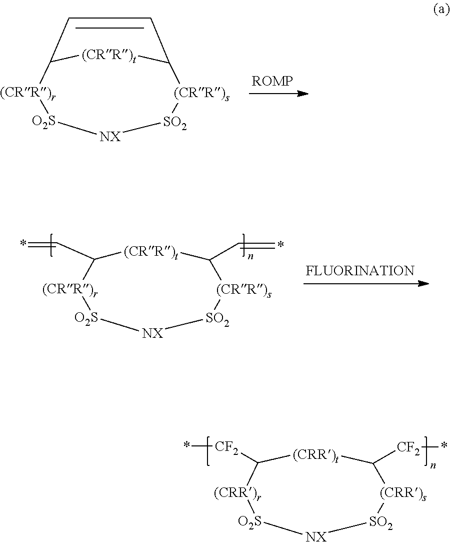

### 4. Manufacturing Method for Imide Monomer

The imide monomer according to the second embodiment of the invention may be manufactured by various methods. For example, the imide monomer that is expressed by the structural formula (3.1) and that satisfies r=s=0 (that is, a divinylsulfonimide) may be synthesized in accordance with the following formula (5.1). That is, the equivalents of trifluoroethenesulfonyl fluoride and trifluoroethenesulfonamide are mixed, and then two equivalents of triethylamine are added to cause a reaction. By so doing, divinylsulfonimide may be synthesized. Alternatively, ammonia or an ammonium salt, such as ammonium carbonate, is caused to act on vinylsulfonyl fluoride to thereby make it possible to synthesize divinylsulfonimide.

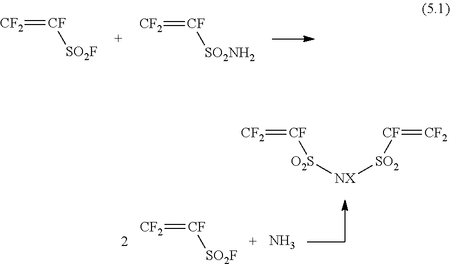

In addition, the imide monomer that is expressed by the structural formula (3.3) and of which (CRR′)ᵣ and (CRR′)ₛ each are CF—CF₃ (that is, cyclic 1,3-disulfonimide having a perfluorovinylidene structure) may be synthesized in accordance with the following formula (5.2). That is, ammonia or an ammonium salt, such as ammonium carbonate, is caused to act on bissulfonyl fluoride having a ketone to thereby make it possible to synthesize cyclic 1,3-disulfonimide. Furthermore, PPh₃ and CF₂Br₂ are caused to act on the cyclic 1,3-disulfonimide to thereby make it possible to synthesize a cyclic 1,3-disulfonimide having a perfluorovinylidene structure.

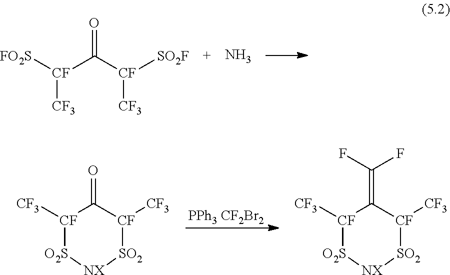

In addition, the imide monomer that is expressed by the structural formula (3.2) and that satisfies r=s=0 (that is, cyclic 1,3-disulfonimide having a vinylene group) may be synthesized in accordance with the following formula (5.3). That is, ammonia or an ammonium salt, such as ammonium carbonate, is caused to act on 1,2-dichloro-1,2-difluoroetane-1,2-sulfonyl fluoride to make it possible to synthesize a cyclic 1,3-disulfonimide. Furthermore, the cyclic 1,3-disulfonimide is reduced by zinc, or the like, to make it possible to synthesize a cyclic 1,3-disulfonimide having a vinylene group.

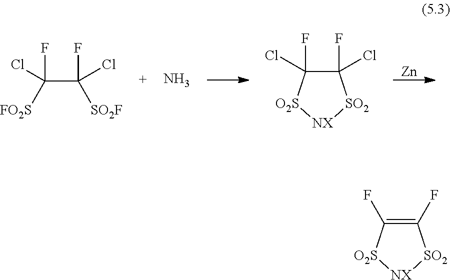

In addition, the imide monomer that is expressed by the structural formula (3.4) and of which (CRR′)ᵣ and (CRR′)ₛ each are CF₂ and Q is oxygen (that is, cyclic 1,3-disulfonimide having a vinyl group) may be synthesized in accordance with the following formula (5.4). That is, a cyclic 1,3-disulfonimide obtained by the same method as that of the formula (5.2) is reduced using H₂/Pt into an alcohol. Subsequently, the alcohol is fluorinated using F₂ and KF. CFCl═CFCl is added to the fluoride, and, furthermore, —FCl—CF₂Cl is reduced to thereby make it possible to synthesize a cyclic 1,3-disulfonimide having a vinyl group.

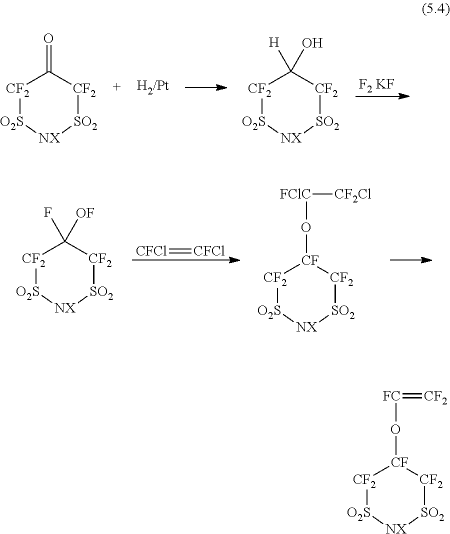

In addition, the imide monomer expressed by the structural formula (3.5) may be, for example, synthesized in accordance with the following formula (5.5). The same applies to the other imide monomers, and the other imide monomers may be synthesized by the same procedure as that of the above method.

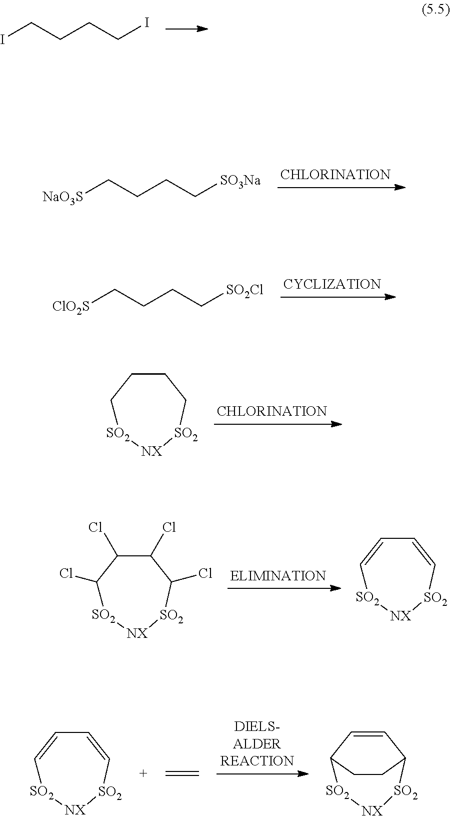

### 5. Battery

A battery according to a fourth embodiment of the invention includes the polymer electrolyte according to the first embodiment of the invention. The battery that uses the polymer electrolyte according to the first embodiment of the invention is specifically (1) a fuel cell that uses the polymer electrolyte according to the first embodiment of the invention for an electrolyte membrane and/or a catalyst layer ionomer, (2) a secondary battery that uses the polymer electrolyte according to the first embodiment of the invention for a solid electrolyte, (3) a solar battery that uses the polymer electrolyte according to the first embodiment of the invention for a solid electrolyte, or the like. When the polymer electrolyte according to the first embodiment of the invention is used for a secondary battery, it is advantageous that the durability improves, the lithium conductivity improves and leakage of liquid is also suppressed. In addition, when the polymer electrolyte according to the first embodiment of the invention is used for a solar battery, it is advantageous that the durability improves and leakage of liquid is also suppressed.

### 6. Operations of Polymer Electrolyte, Manufacturing Method for Polymer Electrolyte, Imide Monomer and Battery

The polymer electrolyte according to the first embodiment of the invention includes an alicyclic structure in its molecule, so the softening temperature increases. Therefore, when the polymer electrolyte is used for a fuel cell, the fuel cell may be operated at high temperatures. In addition, the alicyclic structure is introduced into the molecule, so the oxygen permeability of the polymer electrolyte is improved. Furthermore, a sulfonimide group (—SO₂NHSO₂—) included in a fluorine-containing structure having an alicyclic 1,3-disulfonimide functions as a strong acid group. Therefore, when the fluorine-containing structure is introduced into a principal chain or side chain of a polymer, the proton conductivity of a polymer electrolyte may be enhanced while high oxygen permeability is maintained.

The embodiments of the invention are described in detail above; however, the aspects of the invention are not limited to the embodiments described above. The embodiments of the invention may be modified into various forms without departing from the scope of the invention.

The polymer electrolyte according to the first embodiment of the invention and the manufacturing method for the polymer electrolyte may be used for (1) an electrolyte membrane and a catalyst layer ionomer that are used for various electrochemical devices, such as a polymer electrolyte fuel cell, a water electrolysis device, a hydrohalic acid electrolysis device, a common salt electrolysis device, an oxygen and/or hydrogen concentrator, a humidity sensor and a gas sensor, (2) a solid electrolyte of a secondary battery, and (3) a solid electrolyte of a solar battery, and a manufacturing method therefor. The imide monomer according to the second embodiment of the invention may be used as a raw material for manufacturing such a polymer electrolyte.

1-12. (canceled)

13. A polymer electrolyte comprising a fluorine-containing structure having an alicyclic 1,3-disulfonimide in its principal chain or side chain, wherein
the alicyclic 1,3-disulfonimide is a ring structure in which both terminals of the disulfonimide are linked via at least one carbon atom.

14. The polymer electrolyte according to claim 13, wherein the polymer electrolyte has a structure expressed by any one of the following structural formulas (1.1) to (1.4). 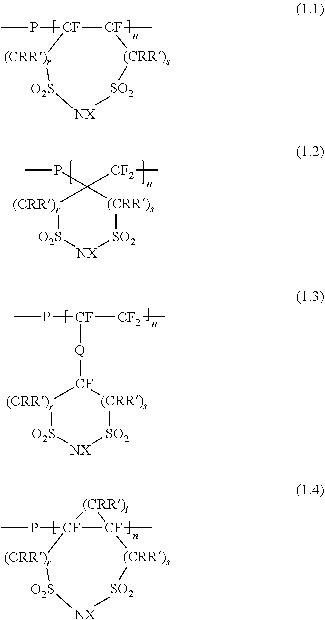
where r, s and t each are an integer larger than or equal to 0; n is an integer larger than or equal to 1; P is a direct bond, a first perfluorocarbon or a hydrocarbon, and the first perfluorocarbon or the hydrocarbon each may include an ether bond and/or a sulfonyl bond; R and R′ each are fluorine or a second perfluorocarbon having a carbon number of 1 to 10, the second perfluorocarbon may include an ether bond and/or a sulfonyl bond, and R and R′ may be the same or may be different from each other in a ring structure; X is hydrogen, an alkali metal or a cation that forms a salt with 1,3-disulfonimide; and Q is a direct bond, oxygen or a third perfluorocarbon having a carbon number of 1 to 10, and the third perfluorocarbon may include an ether bond and/or a sulfonyl bond.

15. The polymer electrolyte according to claim 14, wherein the P has a structure expressed by any one of the following structural formulas (2.1) to (2.6). 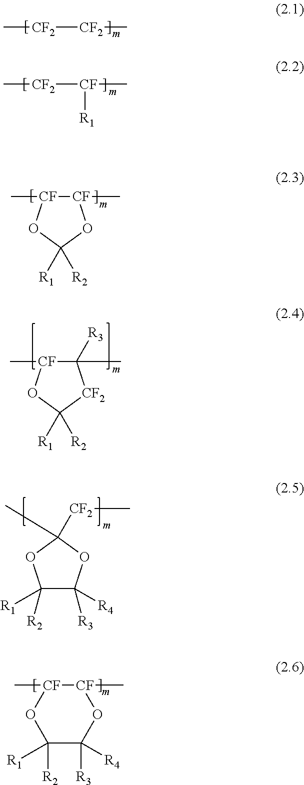
where m is an integer larger than or equal to 1; R₁ to R₄ each are fluorine or a fourth perfluorocarbon having a carbon number of 1 to 10, and the fourth perfluorocarbon may include an ether bond and/or a sulfonyl bond.

16. The polymer electrolyte according to claim 14, wherein the P is the hydrocarbon, and the polymer electrolyte is formed of a block copolymer of the P and the fluorine-containing structure having an alicyclic 1,3-disulfonimide.

17. An imide monomer that is able to introduce a fluorine-containing structure having an alicyclic 1,3-disulfonimide into a principal chain or side chain of a polymer through a polymerization reaction or a combination of a polymerization reaction and a fluorination reaction, wherein
the alicyclic 1,3-disulfonimide is a ring structure in which both terminals of the disulfonimide are linked via at least one carbon atom.

18. The imide monomer according to claim 17, wherein the imide monomer has a structure expressed by any one of the following structural formulas (3.1) to (3.5). 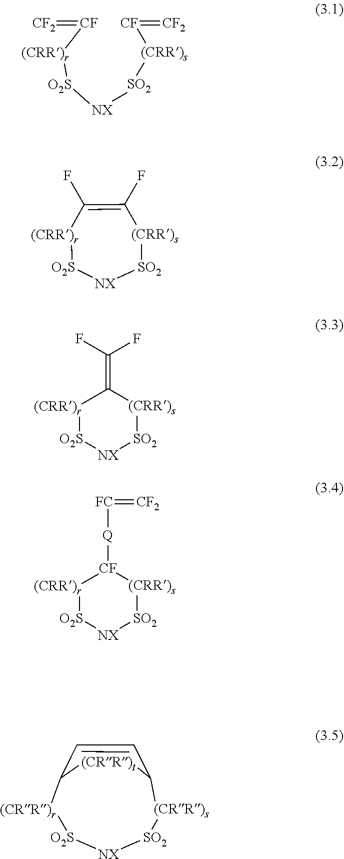
where r, s and t each are an integer larger than or equal to 0; R and R′ each are fluorine or a second perfluorocarbon having a carbon number of 1 to 10, the second perfluorocarbon may include an ether bond and/or a sulfonyl bond, and R and R′ may be the same or may be different from each other in a molecule; X is hydrogen, an alkali metal or a cation that forms a salt with 1,3-disulfonimide; Q is a direct bond, oxygen or a third perfluorocarbon having a carbon number of 1 to 10, and the third perfluorocarbon may include an ether bond and/or a sulfonyl bond; and R″ is hydrogen or a hydrocarbon having a carbon number of 1 to 10, and R″ may be the same or may be different from each other in the molecule.

19. A manufacturing method for a polymer electrolyte, comprising a polymerization step of polymerizing a raw material that includes one or two or more types of imide monomers that are able to introduce a fluorine-containing structure having an alicyclic 1,3-disulfonimide into a principal chain or side chain of a polymer through a polymerization reaction or a combination of a polymerization reaction and a fluorination reaction, wherein
the alicyclic 1,3-disulfonimide is a ring structure in which both terminals of the disulfonimide are linked via at least one carbon atom.

20. The manufacturing method according to claim 19, wherein the one or two or more types of imide monomers have a structure expressed by any one of the following structural formulas (3.1) to (3.5). 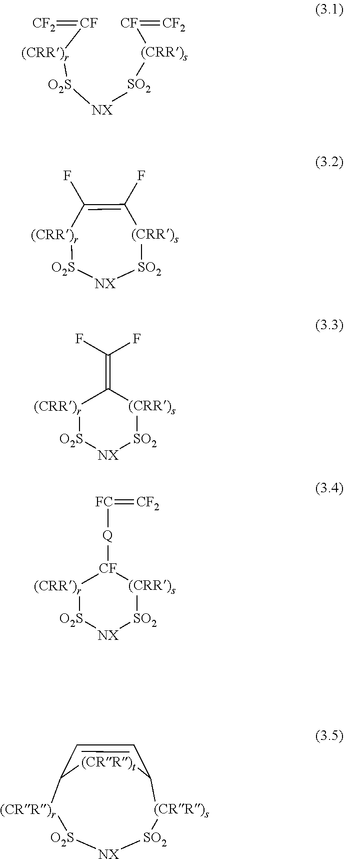
where r, s and t each are an integer larger than or equal to 0; R and R′ each are fluorine or a second perfluorocarbon having a carbon number of 1 to 10, the second perfluorocarbon may include an ether bond and/or a sulfonyl bond, and R and R′ may be the same or may be different from each other in a molecule; X is hydrogen, an alkali metal or a cation that forms a salt with 1,3-disulfonimide; Q is a direct bond, oxygen or a third perfluorocarbon having a carbon number of 1 to 10, and the third perfluorocarbon may include an ether bond and/or a sulfonyl bond; and R″ is hydrogen or a hydrocarbon having a carbon number of 1 to 10, and R″ may be the same or may be different from each other in the molecule.

21. The manufacturing method according to claim 19, wherein the raw material includes the one or two or more types of imide monomers and one or two or more types of second monomers having a polymerizable functional group, and the polymerization step is a copolymerization step of copolymerizing the one or two or more types of imide monomers and the one or two or more types of second monomers.

22. The manufacturing method according to claim 21, wherein the one or two or more types of second monomers each have a structure expressed by any one of the following structural formulas (4.1) to (4.6). 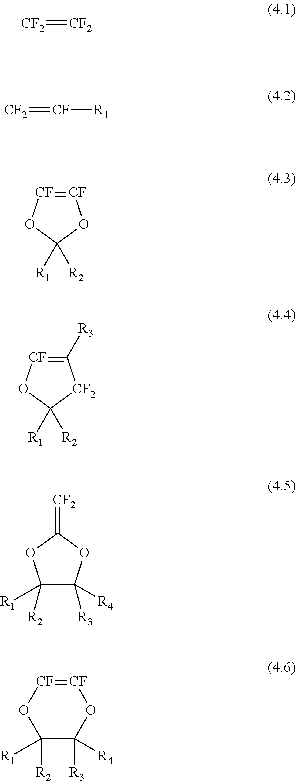
where R₁ to R₄ each are fluorine or a fourth perfluorocarbon having a carbon number of 1 to 10, and the fourth perfluorocarbon may include an ether bond and/or a sulfonyl bond.

23. The manufacturing method according to claim 19, wherein the raw material includes the one or two or more types of imide monomers and one or two or more types of fluorocarbon-based polymers or hydrocarbon-based polymers having a polymerizable functional group, and the polymerization step is a block copolymerization step of block copolymerizing the one or two or more types of imide monomers and the one or two or more types of fluorocarbon-based polymers or hydrocarbon-based polymers.

24. A battery comprising the polymer electrolyte according to claim 13.
